(19) United States
(12) Patent Application Publication
(10) Pub. No.: US 2016/0046399 A1
(43) Pub. Date: Feb. 18, 2016

(54) RIGID CONTAINER FOR CONTAINING FOODSTUFF COMPRISING FISH

(71) Applicant: ETABLISSEMENTS PAUL PAULET, Douarnenez (FR)

(72) Inventors: Benoit RONSIN, Plogonnec (FR); Christine NAULEAU, Quimper (FR); Eric MUCKENSTURM, Quimper (FR); Alain OLIVIERI, La Cadiere d'Azur (FR)

(21) Appl. No.: 14/928,394

(22) Filed: Oct. 30, 2015

Related U.S. Application Data
(62) Division of application No. 13/690,369, filed on Nov. 30, 2012.
Application No. 13/690,369 is a continuation of application No. 12/681,984, filed on Aug. 10, 2010.

(30) Foreign Application Priority Data
Dec. 5, 2007 (FR) 0759588

(51) Int. Cl. B65B 25/00; B65B 51/10; A23L 3/10; A23B 4/16; A23B 4/005; B65B 31/00; B65B 55/12

(52) U.S. Cl. CPC B65B 25/001; B65B 31/00; B65B 51/10; B65B 55/12; A23B 4/16; A23B 4/005; A23L 3/10; A23V 2002/00

(57) ABSTRACT

The invention relates to a rigid container of foodstuff, the foodstuff comprising fist that is present in solid form. The closed container presents substantially no liquid. The invention also provides a method of manufacturing the container and apparatus for manufacturing the container.

The present invention relates to the field of preserving foodstuff, in particular foodstuff comprising fish.

Rigid containers of foodstuff as already known that enable fish for sale to be preserved, e.g. metal cans filled with tuna.

Amongst the foodstuffs that ate preserved in containers of this type, some are in solid form, e.g. tuna in flakes or whole tuna, and the foodstuff is preserved inside the can together with liquid, which liquid can be that referred to as “covering liquid”, e.g. brine of vegetable oil, and comprising a majority of salt water. The covering liquid is needed inside the can for two reasons, namely for cooking and/or sterilizing the tuna (because liquid conducts heat during heating of the can), and also for protecting the tuna against oxidation. It is known that tuna, and fish in general, is particularly sensitive to oxidation since this kind of foodstuff contains more lipids than certain other kinds of foodstuff, such as vegetables.

The covering liquid used for preserving is not intended to be consumed by users. Thus, in order to consume the tuna contained in the can, the consumer opens the can, empties out the juice constituted by the covering liquid into a sink, and then empties the tuna into a dish or a plate.

The present invention seeks to make this type of can more practical for a consumer to use.

To this end, the invention provides a rigid container of foodstuff in which the foodstuff comprises fish in solid form, with the closed container presenting substantially no liquid.

It can be understood that the rigid container is intended to preserve the foodstuff for a long time, where the duration of preservation is longer than 1 month and preferably longer than 3 years (36 months). The rigid container, whether made of metal or of plastics material, can also be referred to as a “can”. It should also be understood that all of its walls, including its cover, are rigid and oxygen-proof.

The term “in solid form” is used of foodstuff to mean that the foodstuff is not liquid. For example, the foodstuff may be in the form of stacks, pieces, filets, flakes, in minced or ground form, or indeed wholes (e.g. whole sardines).

In the context of the present application, it should be observed that the group comprising “foodstuff comprising fish” includes foodstuff comprising shell fish, such as crab or shrimp.

The term “presents substantially no liquid” is used of a container to designate the fact that the container contains a negligible proportion of free liquid, such that there is no need for the consumer, on opening the can, to perform a step of draining off a liquid such as a covering liquid. It will be understood that the container may nevertheless present a few drops of liquid, e.g. for the purpose of flavoring the foodstuff, but that these few drops are in a quantity that bears no relationship with the quantity of covering liquid that is traditionally found preserving foodstuff in solid form and that needs to be drained away prior to consuming the food (the liquid generally presents about 30% by weight of the content of the container). This negligible proportion of liquid preferably does not exceed a liquid content equal to 5% of the total weight of the content of the container, and more preferably the liquid content is less than 1% of said weight. Nevertheless, it can be considered that when the liquid content is less than 10% of the total weight of the content, then the container presents substantially no liquid.

Thus, it is proposed to preserve the foodstuff comprising fish without using covering liquid.

The inventors at the origin of the present invention have observed that the covering liquid is of no use to the consumer. They have carried out tests that show that the liquid can even be undesirable for the consumer, because of the need be drain it off after the can has been opened since this liquid is not consumed together with the foodstuff. It is found that this step of draining off the foodstuff can lead to the consumer losing time, and can also require steps to be taken to dispose of the liquid that can be inconvenient if the consumer is not close to a sink, and the liquid can constitute a juice that is liable to seep out into trash cans. By way of example, the above-proposed container enables the consumer to have a can that is full of tuna flakes without covering liquid, so all the consumer needs to do is open the can and empty the tuna into a dish.

Thus, although solid fish has in the past been preserved using a liquid, because the liquid is considered as being necessary for preserving the fish (indeed standards have been laid down that require covering liquid to be present, e.g., EC Regulation 1536/92 for tuna, or EC Regulation 2136/89 for sardines, which specify minimum ratios between the weight of fish on opening and the net weight of content, this minimum ratio being for example 70% when the covering liquid is water, i.e. a maximum weight of water constituting 30%), the inventors have thus gone against received ideas by eliminating the preserving liquid.

Furthermore, the inventors have found that it is not necessary to have covering liquid for the purpose of sterilizing the foodstuff once the container has been closed. The liquid water needed for transferring heat, e.g. when sterilizing at 121° C., can be supplied directly by the fish before it is cooked. Raw tuna contains 70% water, for example, such that it is this liquid water that serves to transfer heat during heating, and the water of the covering liquid is not essential. It is found that fish, even precooked fish, can provide liquid in sufficient quantity to transfer heat during sterilization.

The invention may also include one or more of the following characteristics:
The foodstuff contained is selected from the group constituted by: tuna, salmon, crab, sardine, shrimp, mackerel, whitefish, each of which may be plain on flavored.
The closed container contains only foodstuff and nitrogen in gaseous form. Thus, the covering liquid traditionally used for preventing the fish from oxidizing is replaced with nitrogen in gaseous form (N_{2(g)}) such that nitrogen in gaseous form constitutes an alternative to the covering liquid for preventing oxidation.
The closed container contains only the foodstuff and water (H₂O_{(g)}) in gaseous form. As with nitrogen, water vapor replaces the covering liquid to prevent the fish oxidizing.
The container presents side walls that are smooth. Thus, the above-presented container does not have any liquid, but that does not mean than its walls need to present stiffening means such as corrugations, where such stiffening means can be necessary when it is desired to evacuate air mechanically from a container. Thus, the inventors behind the invention have found a way of proposing a container that contains no air, thereby avoiding fish oxidizing, but without that requiring the container to be evacuated mechanically.
The container is made of a material selected from aluminum, steel, glass, and a plastics material that is oxygen-proof. The container can thus be a can, whether made of metal or of plastics material, the container nevertheless being rigid, which makes it more difficult to evacuate air mechanically from the container.
The container is cylindrical in shape, of diameter that lies preferably in the range 60 millimeters (mm)to 110 mm.
The container has a liquid content that is less than or equal to 5% of the total weight of the content of the container, and preferably a liquid content that is lean than 1% of said weight.
The container may include a liquid content that is strictly greater than 5% and lees than or equal to 10%.

The invention also provides a method of manufacturing the above-described container, the method including a step of filling foodstuff into the container and a step of eliminating the air present in the container. It is by eliminating air from the container that the foodstuff is prevented from oxidizing once the container has been closed, as described above, thereby making the covering liquid unnecessary. Furthermore, as explained above, there is no need to have covering liquid in order to enable the foodstuff to be sterilized once the container has been closed, contrary to received ideas.

The method may also include one or more of the following characteristics;
The step of eliminating air comprises a step of introducing nitrogen in liquid form into the container.
The step of eliminating air comprises a step of introducing water in gaseous form into the container.

The invention also provides apparatus for manufacturing the container as described above, the apparatus including means for introducing liquid nitrogen into the container.

Finally, the invention provides apparatus for manufacturing the container described above, the apparatus including means for introducing water in gaseous form into the container. These means preferably comprise a steam tunnel and they enable steam to be injected from the sides of the tunnel.

The invention can be better understood on reading the following description given purely by way of example and made with reference to the drawing, in which:

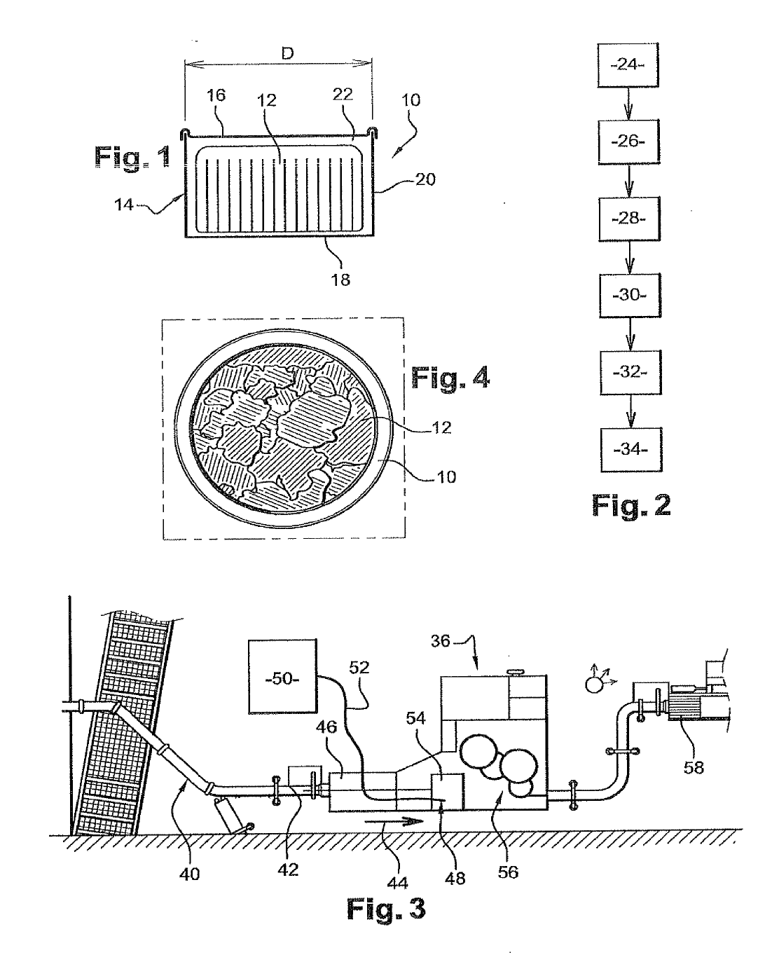

FIG. 1 is a diagrammatic section view of a container in an embodiment of the invention;

FIG. 2 is a diagram showing a method of making the FIG. 1 container;

FIG. 3 is a diagrammatic plan view of an installation including a device for making the container of FIG. 1; and

FIG. 4 is a plan view of a container similar to that showing FIG. 1, once it has been opened by a consumer.

As can be seen in FIG. 1, a container 10 in an embodiment of the invention is filled with foodstuff 12, this foodstuff being in solid form, i.e. it does not flow. For example, it can be in the form of a solid block, of filets, of steaks, of pieces, of flakes, in minced form, or indeed in the form of a whole fish.

The foodstuff 12 comprises fish (where this term also includes shell fish), so it has lipids that are liable to become oxidized. The fish may be any type of fish suitable for being preserved in a container, in particular tuna, salmon, sardine, crab, shrimp, etc. In the example of FIG. 1, there is shown diagrammatically a whole piece of tuna, e.g. tuna of skipjack or Albacore type or any type of tuna, and in FIG. 1 the tuna is shown in flakes. The foodstuff 12 need not be constituted solely of fish, but may include other foodstuffs, in particular additives, preservatives, or indeed a small amount of oil for flavoring purposes.

As can be seen in FIG. 1, once the container 10 is closed it presents substantially no liquid. It will be understood that the foodstuff 12 may initially be loaded into the container 10 together with the liquid, e.g. oil or a little water, but once the container 10 has been closed for the purpose of being put on sale to consumers, the container no longer contains any liquid inside it, which liquid might have been absorbed, e.g. during heating. For example, oil or water added prior to closing the container may represent 2% to 10% by weight of the fish, and preferably 2.4% to 6.5% by weight of the fish. The added liquid may be constituted in particular by water, sunflower oil, olive oil, or any other type of oil. Furthermore, it can be understood that, once closed, the container 10 may present traces of liquid, e.g. in the form of drops, but that this quantity of liquid is not so great as to require the liquid to be drained off prior to consuming the foodstuff. Thus, when the consumer opens the container 10 and empties it out into a dish, it is possible for example to obtain an appearance similar to that shown in FIG. 4, without it being necessary to perform any prior step of draining off a liquid. It is thus possible that drops of liquid are present in the container, but the quantity of liquid in the container does not exceed 10% or even 5% of the total variant of the content of the container 10, and is preferably even less than 1% of said weight. It may be observed that this liquid content is well below that which is additionally found in foodstuff cans that include a covering liquid, with the liquid content under such circumstances constituting, in practice, close to 25% of the total weight of the content of the container.

As can be seen in FIG. 1, the container 10 comprises a receptacle 14 and a cover 16. In this example, the container 10 is made of steel, with the cover 16 being crimped onto the receptacle 14, however it could equally well be made in the same manner out of aluminum. In a variant, the container 10 is made of a plastics material, the cover 16 being heat-sealed onto the receptacle 14, with the plastics material comprises a so-called “barrier material” that is oxygen-proof, e.g. a multilayer material of the polypropylene/EVOH/polypropylene type (where EVOH is ethylene vinyl alcohol), or indeed a single layer material such as polyethylene. In another variant, the container 10 is a glass jar. It should be understood that all of the walls of the container, including the cover 16, are rigid and oxygen-proof.

In the example of FIG. 1, the container 10 is cylindrical in shape, the receptacle 14 having a bottom 18 in the form of a disk and side walls 20. Because of the method whereby the container 10 is made, these wails 20 do not need to be reinforced by corrugations since there is no need to evacuate air mechanically from the container. The bottom 18 preferably has a diameter lying in the range 60 mm to 110 mm. Furthermore, the container 10 may be of greater or smaller capacity, and in particular it may contain foodstuff 12 of weight lying in the range 80 grams (g) to 2 kilograms (kg).

The container 10 shown in FIG. 1 is appertized, i.e. it has been treated to preserve perishable foodstuff that has been sterilized by heat. Once it has been made, i.e. once it is ready for sale, the container 10 contains only the foodstuff 12 and gas 22, possibly together with a few traces of liquid, as explained above. The gas 22 is a gas that is not liable to oxidize the foodstuff 12, In one embodiment, the gas 22 is nitrogen N_{2(g)}. In another embodiment, the gas 22 is water vapor H₂O_{(g)}. The quantity of gas 22 relative to the quantity of foodstuff 12 may vary from one container to another, in particular as a function of the form of the foodstuff 12.

It should be observed that a few traces of dioxygen O₂ may be present in the gas 22, but in traces only, the volume content of bioxygen compared with the quantity of the other gas being less than 15%, and preferably less than 5%.

It should to observed that the gas 22 does not include any atoms of oxygen that are easily released, unlike air, for example, such that the gas 22 is not likely to oxidize the foodstuff 12, which oxidation could give rise to a bad taste or to a change in the color of the foodstuff 12. Furthermore, in spite of the absence of covering liquid in the container 10, the container 10 can be sterilized by heating, with heat transfer being provided by the water contained in the foodstuff prior to being heated.

The method of manufacturing the container 10 is described below with reference to FIG. 2.

The method of manufacture begins with a step 24 of cooking or precooking the foodstuff 12, e.g. whole tuna or salmon. This step 24 is followed by a step 26 of filleting the fish, this step comprising for example skinning, boning, and cutting up the fish. The step 26 is followed by a step 28 of filling the container 10, and more precisely a step of filling the receptacle 14 with a measured quantity of foodstuff 12. This filling step is also referred to as canning.

The canning step 28 is followed by a step 30 of eliminating the air that is present together with the foodstuff 12 inside the receptacle 14. This air-elimination step 30 includes a step of introducing liquid nitrogen into the receptacle, and a step of expanding the liquid nitrogen, which vaporizes and expels the air that was present in the receptacle 14. More precisely, nitrogen N_{2(f)} introduced in liquid form, e.g. a drop of nitrogen, the nitrogen previously being stored at a temperature of −176° C. and at a pressure of 1 bar. When nitrogen is introduced in the receptacle 14, at ambient temperature, it vaporizes almost instantaneously. The gaseous nitrogen entrains the air that was initially present in the receptacle 14 and expels it so that there remains only nitrogen, in gaseous form at the end of step 30.

Step 30 is quickly followed by a step 32 of closing the can, e.g. by crimping, during which the cover 16 is fastened permanently and hermetically onto the receptacle 14. Once closed in permanent and hermetic manner, the foodstuff 12 enclosed is the container 10 can be sterilized during a step 34 of heating the container, with heating taking place at a minimum of 121° C., so as to obtain satisfactory sterilization. Nevertheless, sterilization can take piece at a lower temperature, e.g. about 116° C. to 117° C.

In another implementation of the method, the step 30 is replaced by a step of introducing water vapor, during which water in gaseous form is injected by overflowing into the receptacle 14, thereby expelling the air that was present in the receptacle, this injection then being quickly followed by the step 32 of closing the container. It should be observed that it is necessary to provide a contact time between the vapor and the foodstuff that is sufficient, e.g. lying in the range 20 seconds (s) to 30 s per container (i.e. 240 cans per minute over a 6 meter (m) length of a steam injection tunnel).

At the end of step 34, a container 10 is available that is suitable for selling to consumers.

It should be observed that the manufacturing method does not include a juicing step during which the covering liquid is inserted into the can. The method of manufacturing a container containing covering liquid would cause step 30 to be replaced by a step of introducing the covering liquid, with the covering liquid serving to prevent the foodstuff 12 from oxidizing, and also to enable heath to be transferred during the heating step 34.

In implementations of the method in which water vapor is introduced, the container may present the following characteristics:

| | Foodstuff 12 with | Foodstuff 12 with |
|---|---|---|
| | a little water | a little oil |
| | during filling | during filling |
| Quantity of fish filled in prior | 127 g | 122 g |
| to closing container | | |
| Amount of water or sunflower | 3 g | 8 g |
| oil added prior to closing | | |
| container | | |
| Net weight | 130 g | 130 g |
| Vacuum in container once | 10 inches Hg | |
| closed | | |
| Sterilization | 47 minutes at 117° C. | |
| Quantity of liquid after | 6 g | 10 g |
| sterilization | | |

Furthermore, in an implementation of the method with nitrogen being injected, about 1 g of nitrogen in injected per container, using an injection time of 115 milliseconds (ms) and an injection pressure of 1.2 bar. The residual quantity of oxygen for a foodstuff 12 comprising tuna preferably lies in the range 5% to 7.5%. The residual quantity of oxygen for a foodstuff 12 comprising salmon preferably lies in the range 10% to 13%. The sterilization is implemented in 36-minute cycles, at a temperature of about 117° C.-119° C.

The apparatus for manufacturing the container 10 is described below, with reference to FIG. 3.

The installation in which the manufacturing apparatus 36 is mounted comprises a production line 40 for mating containers. The production line comprises a conveyor belt delivering receptacles similar to the receptacle 14. At the inlet 42 to the manufacturing apparatus, the receptacles 14 are empty and they travel in the direction given by arrow 44. The receptacles 14 pass initially through a filler tool 46 so as to perform the step 28 of filling the receptacle with foodstuff 12, and they then pass through a tool 48 for eliminating the air present in the receptacle 14. This elimination tool includes means for introducing liquid nitrogen into has container. These introduction means comprise means 50 for storing nitrogen in liquid form, a flexible hose 52 enabling the nitrogen to be delivered, and means 54 for measured dispensing of liquid nitrogen into each receptacle. The means 54 enable a small quantity of nitrogen, e.g. one drop, to be injected, which nitrogen then vaporizes so as to expel the air present in the receptacle so as to perform step 20 of the method. The receptacles are then closed, by fitting on the cover 16, using crimping or heat-sealing means 56, enabling the container 10 to be closed hermetically. Once closed, the containers 10 are taken to storage means 58 for sale to consumers.

It will be understood that when water vapor is injected into the receptacles 14, the means for eliminating air are different. Specifically, the means 50, 52, and 54 are replaced by means for injecting water vapor into the receptacles. These means 50, 52, 54 are formed in a steam tunnel, e.g. having a length of 6 m. Preferably, steam is injected from the sides of the tunnel on either side of the containers, thereby enabling an atmosphere of steam to be created, while preventing drops of water depositing in the containers.

Finally, it should be observed that the invention is not limited to the embodiments described above.

Amongst the advantages of the invention, it should be observed that containers 10 are provided that do not contain any covering liquid.

In passing, it is found that a can having no covering liquid is easy to use and enables the weight and/or the size of the can to be reduced, thereby producing savings in transport costs.

1. A method of manufacturing a rigid container containing foodstuff, the container comprising:
a receptacle and a cover, the container being made of a material selected from the group consisting of aluminum, steel, and a plastics material that is oxygen-proof, the cover being seamed or heat-sealed onto the receptacle before a sterilization step, the foodstuff consisting of:
(a) tuna that is in solid form and optionally (b) at least one member selected from the group consisting of additives, preservatives, and an amount of oil or water, the method comprising:
filling pre-cooked tuna and optionally at least one member selected from the group consisting of additives, preservatives, and an amount of oil or water, that ranges from 2 to 10% by weight of the tuna into the container;
after the filling step, eliminating substantially all the air present in the filled container, wherein eliminating air present in the container comprises introducing a gas into the container that will not oxidize the foodstuff; and
closing the container quickly and sterilizing the foodstuff in the container such that the closed container presents substantially no liquid after sterilization and a liquid content is less than 10% of a total weight of a content of a container.

2. A method of manufacturing a rigid container containing foodstuff, the container comprising a receptacle and a cover, the container being made of a material selected from the group consisting of aluminum, steel, and a plastics material that is oxygen-proof, the cover being seamed or heat-sealed onto the receptacle before a sterilization step, the foodstuff consisting of fish that is in a solid form, and optionally at least one member selected from the group consisting of additives, preservatives, and a small amount of oil or water, the method comprising:
cooking or pre-cooking the foodstuff;
filling the cooked or pre-cooked foodstuff into the container;
eliminating air present in the container, wherein eliminating air present in the container comprises introducing a gas into the container that will not oxidize the foodstuff, the gas being nitrogen in gaseous form; and
closing the container such that the closed container presents substantially no liquid after sterilization and a liquid content is less than 10% of a total weight of a content of the container.

3. The method according to claim 1, wherein the container is not reinforced by corrugations side walls.

4. The method according to claim 1, wherein the liquid content is less than or equal to 5% of the total weight of the content of the container.

5. The method according to claim 1, wherein the liquid content is less than 1% of the total weight of the content of the container.

6. The method according to claim 1, wherein the liquid content is greater than 5% and less than 10% of the total weight of the content of the container.

7. The method according to claim 1, wherein the foodstuff is in a form that is selected from the group consisting of steaks, pieces, filets, flakes, minced, ground, and whole.

8. The method according to claim 1, wherein the volume content of dioxygen is less than 5%.

9. The method according to claim 1, wherein the foodstuff includes the at least one member selected from the group consisting of additives, preservatives, and a small amount of oil or water that ranges from 2 to 10% by the weight of the tuna.

10. The method according to claim 1, wherein no covering liquid is inserted into the can.

11. The method according to claim 1, wherein the at least one member is selected from a group consisting of oil and water.

12. The method according to claim 11, wherein the tuna that is in solid form is flavored.

13. The method according to claim 1, wherein the amount of oil or water that ranges from 2.4% to 6.5% by the weight of the tuna.
